(19) United States
(12) Patent Application Publication
(10) Pub. No.: US 2024/0129602 A1
(43) Pub. Date: Apr. 18, 2024

(54) Video Summariser

(71) Applicant: 1Bstories Pte. Ltd., Singapore (SG)

(72) Inventors: Ravi Hamsa, Bangalore (IN); Anuvrat Rao, Singapore (SG)

(21) Appl. No.: 18/071,909

(22) Filed: Nov. 30, 2022

(30) Foreign Application Priority Data
Oct. 17, 2022 (IN) 202211059202

(51) Int. Cl. H04N 21/8549; G06F 40/279; G10L 15/26; G10L 25/57; G10L 25/78

(52) U.S. Cl. CPC H04N 21/8549; G06F 40/279; G10L 15/26; G10L 25/57; G10L 25/78

(57) ABSTRACT

Systems and methods are described for selecting a video clip of one or more video segments from an origin video. Video data comprising video images and associated data of the origin video is received. Text pieces are derived from the associated data and timing information indicating a time in the video associated with the text piece is stored in a data structure. Significant ones of the text pieces are selected and a portion of the video associated with each significant text piece is output.

### FIELD

This application relates to a computer implemented method and system for summarising a video.

### BACKGROUND

Video is commonly used as a way of providing content to users on a variety of different platforms. A content provider may generate video content which he wishes to make available on platforms such as Twitter, LinkedIn, Facebook, etc. A video comprises a sequence of images which are displayed at a certain rate so that a view of perception is to see a moving image. Many videos also include subtitles, where a subtitle may extend over a set of the images so as to be associated with a particular portion of the video. Many videos may also comprise or be associated with spoken audio data.

A content provider may provide a video in the expectation that the entire video will be viewed, and its content consumed, in an appropriate manner. However, in reality, videos above a certain length may not be consumed in full because a consumer may not take the time to view the full duration. Important content may be overlooked.

It is an aim of the present disclosure to address this challenge, and any other challenges that would be apparent to the skilled reader from the disclosure herein.

### SUMMARY

It is a particular but not exclusive aim of the disclosure to provide techniques for summarising a video to generate one or more video clip of summarised video data for consumption.

According to one aspect of the invention there is provided a computer system for selecting a video clip of one or more video segments from an origin video, the computer system comprising:

a data input configured to receive video data of origin video, the video data comprising video images and associated data;
a text extraction component configured to derive from the associated data text pieces and to store in a data structure timing information which indicates for each text piece the time in the video associated with that text piece;
a selection component configured to select from the derived text pieces one or more text piece of significance; and
a video clip generation component configured to extract from the data structure for each text piece of significance the time in the video associated with that piece of significance and to output as a video clip a portion of the video at that time.

In some embodiments, the associated data comprises text data embedded in the video data.

In some embodiments, the associated data comprises speech and wherein the computer system comprises a speed-to-text convertor configured to derive text pieces by converting the speech to text.

In some embodiments, the selection component comprises a Bidirectional Encoder Representations from Transformers (BERT) neural network.

In some embodiments, the selection component comprises a Queryable Extractible Summarizer.

In some embodiments, the video clip generation component is configured to output multiple video clips in sequence.

In some embodiments, the computer system comprises a paragraph generation component which is configured to receive a desired time of duration of a video clip, and to generate virtual sentences from the text data concatenated into paragraph, based on the desired time of duration.

In some embodiments, the computer system comprises a clip adjustment component which is configured to implement an adjustment of a time duration of the video clip based on speaker continuance.

In some embodiments, the clip adjustment component is configured to detect that a first speaker is continuing to speak after an original end of the video clip and to extend the duration of the video clip to an end time of the speaker continuance of the first speaker.

In some embodiments, the clip adjustment component is configured to detect that a second speaker has ceased speaking less than a predetermined time prior to the original end of the video clip, and to reduce the time of duration of the video clip by the predetermined time.

In some embodiments, the computer system comprises a video rendering component configured to render images of the segment of the video in a screen container at a user device.

In some embodiments, the video rendering component is configured to render each video segment in a respective screen of a multiscreen user engagement experience.

According to another aspect of the invention there is provided a method for generating a video clip from an origin video, the method comprising:
receiving video data of an origin video, the video data comprising video images and associated data;
deriving from the associated data text pieces and storing in a data structure timing information which indicates for each text piece the timing of the video associated with that text piece;
selecting from the derived text pieces one or more text piece of significance; and
extracting from the data structure of each text piece of significance the timing of the video associated with that piece of significance and outputting as a video clip a portion of the video at that time.

In some embodiments, the associated data comprises text data embedded in the video data.

In some embodiments, the associated data comprises speech and wherein the method comprises converting the speech to text to derive the text pieces.

In some embodiments, selecting one more text piece of significance is carried out using a neural network.

In some embodiments, the method comprises determining a common length for each of the derived text pieces and deriving the text pieces of a length which substantially matches the common length.

In some embodiments, the method comprises determining the common length for the derived text pieces based on a desired time of duration of video clip, wherein the video clip comprises multiple sequential text pieces of the common length.

According to another aspect of the invention there is provided computer readable instructions stored on a transitory or non-transitory computer readable media which, when executed by a hardware processor, implement the method of generating a video clip from an origin video, the method comprising:
receiving video data of an origin video, the video data comprising video images and associated data;
deriving from the associated data text pieces and storing in a data structure timing information which indicates for each text piece the timing of the video associated with that text piece;
selecting from the derived text pieces one or more text piece of significance; and
extracting from the data structure of each text piece of significance the timing of the video associated with that piece.

A “story” format for consumption has recently been developed which provides a multiscreen user engagement experience. The present video summarization techniques are useful to provide video for consumption in that format.

According to another aspect disclosed herein, there is provided a computer system comprising a processor and a storage, the storage storing computer-readable instructions, which when executed by the processor, carry out any of the methods described herein.

According to another aspect of the invention there is provided a computer program product comprising instructions which, when executed by a computer device, cause the computer device to perform any of the methods set forth herein.

According to another aspect of the invention there is provided a tangible non-transient computer-readable storage medium is provided having recorded thereon instructions which, when executed by a computer device, cause the computer device to perform any of the methods set forth herein.

### BRIEF DESCRIPTION OF THE DRAWINGS

For a better understanding of the present disclosure and to show how embodiments may be carried into effect, reference is made by way of example to the accompanying drawings in which:

FIG. 1 is a schematic block diagram of a video summarisation system.

FIG. 2 is a schematic flowchart illustrating operation of the system of FIG. 1.

FIG. 3 is a schematic diagram illustrating the association of image data with subtitle data in a video.

FIG. 4 shows three pages of an exemplary online resource provided in a “Multi-screen User Engagement”, or “Web Story” format.

FIG. 5a is a diagram of subtitles divided into word sequences of a common duration.

FIG. 5b is a diagram showing the output of a BERT model text summarizer.

FIG. 6 is a flow chart illustrating a clip length adjustment feature.

In the drawings, corresponding reference characters indicate corresponding components. The skilled person will appreciate that elements in the Figures are illustrated for simplicity and clarity and have not necessarily been drawn to scale. For example, the dimensions of some of the elements in the Figures may be exaggerated relative to other elements to help to improve understanding of various example embodiments. Also, common but well understood elements that are useful and necessary in a commercially feasible embodiment are often not depicted in order to facilitate a less obstructive view of these various example embodiments.

### DETAILED DESCRIPTION OF EMBODIMENTS

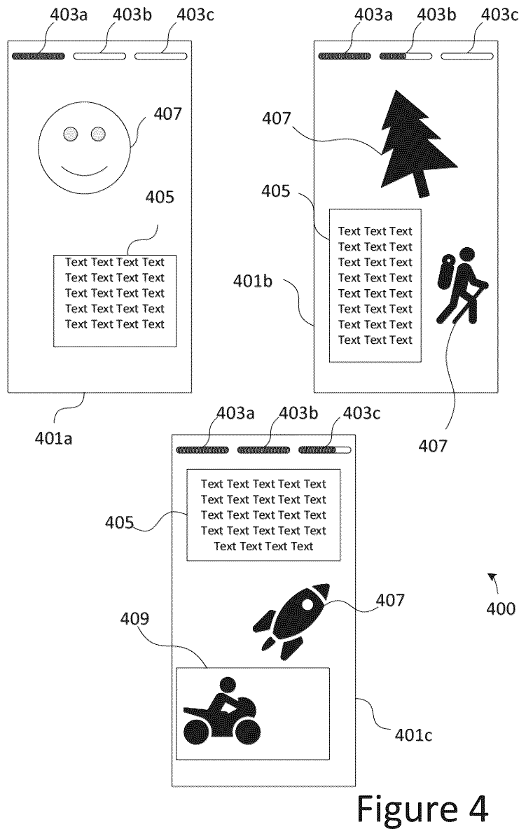

By way of background, reference is made to FIG. 4, which shows a highly schematic diagram illustrating three pages 401a, 401b, 401c of an exemplary web story 400, or Multi-screen User Engagement Experience (MUEE, for short), which may be rendered on a display of a client device. Provided on each page 401 of the exemplary MUEE 400 is a quantity of page indicators 403, wherein the quantity of page indicators 403 corresponds one-to-one with the quantity of pages provided in the MUEE 400. That is, a particular page indicator, e.g., 403a, 403b, 403c, represents a particular respective page 401a, 401b, 401c within the MUEE 400. The order in which the page indicators 403a, 403b, 403c are arranged from left to right on the device may render the first page 401a upon accessing the MUEE 400, and may then render the second page 401b upon receipt of a qualifying user input, or upon lapse of a predetermined time period.

When a particular page 401 of the MUEE is viewed by a user—that is, when the display device renders a particular one of the quantity of pages, e.g., 401a— a visual effect may be applied to a corresponding page indicator 403a such that the user may visually determine which page 401 within the MUEE 400 is presently rendered on the display device. In an embodiment in which a next page 401b of the MUEE is rendered when a predetermined amount of time has passed whilst viewing the first page 401a, the visual effect of the first page indicator 403a may extend or grow from a left-hand side of the indicator 403a as the predetermined time elapses until the predetermined time period has passed, at which point the visual indicator fills the entire page indicator 403a.

For example, on page 401b of the MUEE 400 in FIG. 4, a left-half of the page indicator 403b comprises a visual effect, indicating that the user is viewing page 401b and has been viewing it for half of a predetermined period of time. In some embodiments, such as that shown in FIG. 4, page indicators representing pages 401 which precede a presently viewed page 401 may retain the visual effect when they have been viewed and a next page 401 is rendered.

FIG. 4 further demonstrates the types of content that may be provided on a page 401 of a MUEE 400. For example, the first, second and third pages, 401a, 401b, and 401c respectively, all comprise a text region 405, which may comprise text of any font, size, weight or other text attribute. Each page 401 further comprises one or more image 407. Page 401c further shows an exemplary video 409 which is embedded into that page 401c of the MUEE 400, and which may play automatically upon rendering the third page 401c.

It will be appreciated that, generally, a page 401 of a MUEE may comprise any number of text regions, images, videos, or content in any other media format. The pages 401a-401c of FIG. 4 are provided by way of example only.

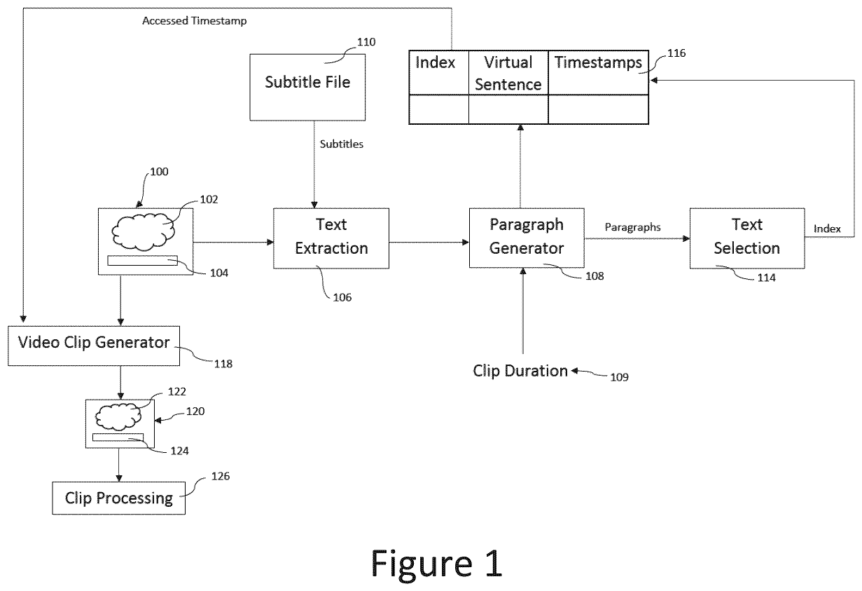

FIG. 1 is a schematic diagram of a video summarisation system. The video summarisation system operates to generate one or more video clip from an origin video, the one or more video clip representing video of significance to a consumer. Significance is determined by analysing text associated with the video data. Pieces of text which are considered to be significant are used to determine the associated portions of video to be utilised in the one or more video clip. Each video clip may be presented in a screen of the MUEE, for example, as shown in FIG. 4 at reference 409.

As described herein, the video summarisation system of FIG. 1 is configured to receive video data 100. The video data may be encapsulated in a file. The video data may incorporate subtitles and/or associated audio data. In certain embodiments, a single file may comprise both video data and audio data. The video data and audio data are each encoded using a suitable encoding format. The file itself may also be of a suitable container file format. Example video encoding formats include H.264, HEVC, VP9. Example audio encoding formats include NP3, MC, AC33. Example container file formats include MPEG-4(moving pictures expert group-4), HTTP live streaming, H5, audio video interleaf, AVI.

In other examples, video data and audio data may be received as separate files. In certain circumstances, multiple items of video data and/or audio data may be received. For example, one video may be stored in several files each representing a sub-part (e.g., a chapter or scene of the video). Where the video data is associated with audio data, the audio data may be a soundtrack intended to accompany the video data. The audio data comprises at least speech and may include other audio. For the purposes of the video summarisation system, it is speech in the audio data which is of most interest.

The video summarisation aims to generate a short synopsis that summarises video content by selecting its most informative and important parts into one or more videoclip which may be used for example in a multiscreen user engagement experience.

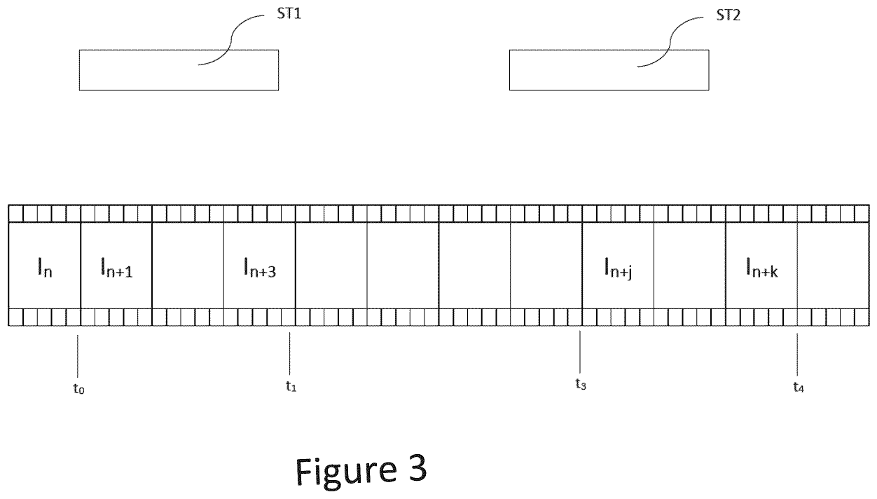

Reference numeral 100 denotes incoming video data of video content to be summarised. The video data comprises a moving image (implemented by a sequence of image frames in a video). The moving image is denoted by reference numeral 102 and is shown in a highly schematic fashion. It is common in videos that a subtitle is presented for each particular set of moving images, sometimes referred to herein as a video segment or video portion. This subtitle may take the form of text. Reference numeral 104 denotes a subtitle associated with the set of moving images 102. It will readily be appreciated that the video content 100 comprises a series of moving images, each set of which may be associated with a particular subtitle. Video data incorporates timing information, for example in the form of time stamps. There may be a time stamp (or time code) associated with each image frame of the video, or a time stamp associated with each portion of the video. In any event, each subtitle may be associated with a particular time stamp which denotes the start of that subtitle, and which therefore associates the subtitle, in time, with the set of moving images to which the subtitle relates. FIG. 3 is a schematic diagram illustrating the timing relationship between subtitles and video portions. The video data includes a subtitle file 110 (shown separately in FIG. 1 for ease of reference).

One form of subtitle file is a Sub-Rip subtitle (SRT) file 110. It is a plain text file that contains information regarding subtitles, including start and end time codes of the text and the sequential number of subtitles. FIG. 3 shows diagrammatically a sequence of images associated with subtitles which may be in a separate subtitle file, such as an SRT file. A first subtitle ST1 is associated with images In+1 . . . In+3, and has a start time code at t0 and an end time code at T1.

A second subtitle is associated with images In+j . . . In+k and has a start time code of t3 and an end time code of t4. Note that subtitles may be continuous throughout the video, or there may be portions of other audio (noise, music, sound effects) or silence in between.

As described later, if the subtitle ST1 was considered to represent a text piece of significance, the video portion comprising the set of images In+1 . . . In+3 would be associated with the subtitle using the timecodes t0, t1 and as such be included in the summarised video clip.

The subtitles may be alternatively derived from an audio file by speech-to-text conversion. When speech-to-text conversion is used to obtain text to be analysed for its significance, speech from the audio file may be converted into text. In the audio file, there is a similar association of pieces of audio data with the associated sets of images, using time codes.

The computer system comprises a text extraction component 106 which receives the video data and subtitle file from the video 100. The computer system further comprises a paragraph generator 108 which receives subtitles which have been extracted by the text extraction component 106. The paragraph generator receives a clip duration parameter 112 which controls the operation of the paragraph generator in a manner to be more fully described. In brief, the paragraph generator receives subtitles from the text extraction component 106 and converts them to paragraphs having a certain number of sentences (or ‘virtual sentences’) of a certain length depending on the clip duration parameter 112. The paragraph generator organises the subtitles into word sequences comprising sentences or “virtual sentences” each having a duration determined according to a desired common duration (for example 2s) and creates an index file 116 which holds a sentence index, its virtual sentence and the associated start and end time codes. The computer system further comprises a text selection component which receives paragraphs from the paragraph generator 108. The text selection component 114 extracts text pieces of significance from the paragraphs supplied by the paragraph generator 108. This may be done using deep learning inference as more fully described later, or in other ways. The text selection component 114 supplies an index of the or each subtitle which has been selected to be of significance to a data structure 116, from which the time codes can be accorded.

The computer system further comprises a video clip generator 118 which is used to access video clips from the video data based on the time codes of subtitles which have been selected by the text selection component as being of significance. In the embodiments described herein, the text selection component provides paragraphs of interest, each paragraph having a duration matching the desired duration of a video clip. The paragraph comprises the word sequences derived from the subtitles, with their indices. The video clip generator 118 generates one or more video clip which is designated by reference numeral 120 and is illustrated highly schematically. The video clip 120 may have a set of images providing a moving image 122 and a paragraph of one or more subtitle which has been selected to be of significance 124. The video clips generated by the video clip generator may be supplied to a clip processing component 126.

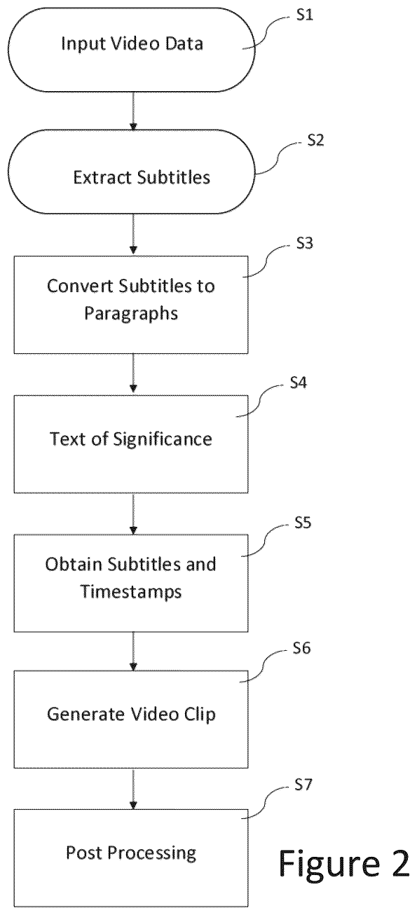

FIG. 2 is a flowchart which illustrates schematically the steps taken in the video summarisation process. The video data is input at step S1. In step S2, subtitles are extracted with their subtitle indices. Step S2 is carried out in the text extraction component 106 to provide processed subtitles. In step S3, the subtitles are converted to paragraphs containing a certain number of sentences. The number of sentences depends on the clip duration parameter which is supplied to the paragraph generator 108. The clip duration parameter 109 governs the length of each sentence/virtual sentence and the number of sentences in a paragraph.

Note that in certain embodiments, the video data may not have text subtitles. In that case, there may be speakers in the video which thus has an associated audio recording representing the speech. In that case, the speech may be converted to text using a speech-to-text converter. This is not shown in FIG. 1, but may be placed, for example, before the input of the text extraction component 106 and may supply text to the text extraction component 106. Note that speech-to-text conversion is known, for example a speech-to-text API which may be utilised in this context is found at https://cloud.google.com/speech-2-text. In one example, the audio data is transmitted to a suitable cloud speech-to-text service 20. Examples of such services include those provided by Amazon Web Services, Google Cloud, Microsoft Azure, Otter.ai or IBM Watson. In response to the transmission of the audio data, the system 100 receives corresponding text data comprising the transcription.

At step S4, text of significance is selected. In this step, the aim is to extract automatically the important virtual sentences derived from the subtitles. This could be carried out for example, using deep learning models. One such deep learning model is described in “Papers with code—Leveraging BERT for Extractive Text Summarisation on Lectures 2019”.

In an alternative approach, a queryable extractive summariser may be utilised, for example if the user wished to obtain summarisation related to a certain query. A queryable extractive summariser is described in “Papers with code—CXDB8: A queryable extractive summariser and semantic search engine: 2020”. CX_DB8 is a queryable word level extractive summariser and evidence creation framework which allows for rapid summarisation of arbitrarily sized text. CX_DB8 uses an embedded framework Flair. CX_DB8 functions as a semantic search engine and has application as a supplement to traditional “find” functionality in programs and web pages. It has been developed for use by competitive debaters and is made available to the public at https://github.com/helisotherpeople/cx db8.

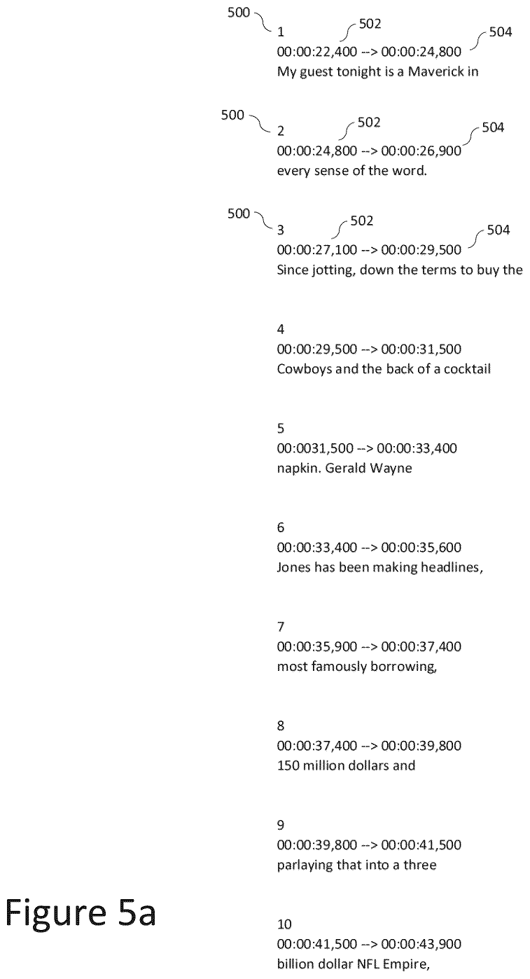

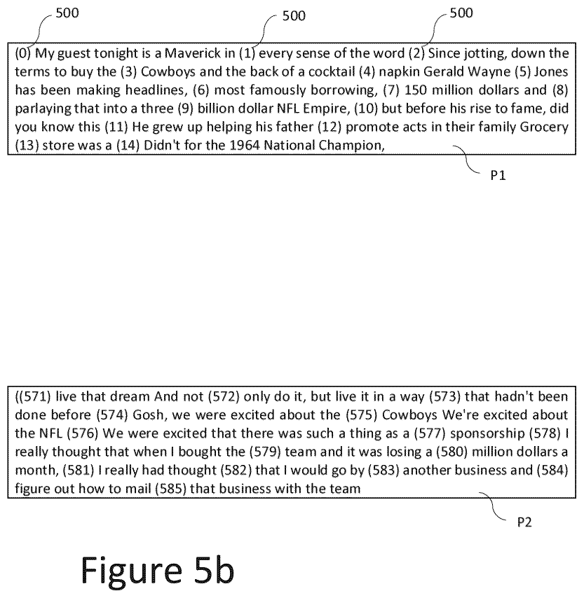

The text selection component 114 supplies outputs from which the indexes only are extracted. The output is shown in more detail in FIG. 5b,

In step S5, the output indexes are used to access the associated time codes from the data structure 116. This time stamp may be applied to the video clip generator to identify the video portion for a video clip.

At step S6, the video clip generator uses a suitable library to clip the video into clips according to the extracted time stamps for the parts which have been deemed of significance. A movie py library may be used for this purpose. See for example https://zcode.github.io/moviepy/. The movie PY code provides a clip class which includes a sub-clip function. A sub-clip function returns a clip playing the content of the current clip between times start time and end time, which may be expressed in seconds, minutes or hours or as a string. This sub-clip function may be used to return a clip based on the start time codes and end time codes as discussed herein.

A Video Clip function in movie PY also allows the size of the image of the video to be adjusted. A size attribute of the clip (with, height) in pixels may be specified. This function is useful when the clip is to be presented in a screen container of a certain size in an MUEE.

During clipping, one possibility is to clip the clips individually. Another possibility is to clip and concatenate them into one video summarisation. The option which is chosen will depend on the manner in which the video clips are intended to be rendered in a multiscreen user engagement experience. For example, one clip per screen of the MUEE may be provided in an MUEE file to be consumed at a user device.

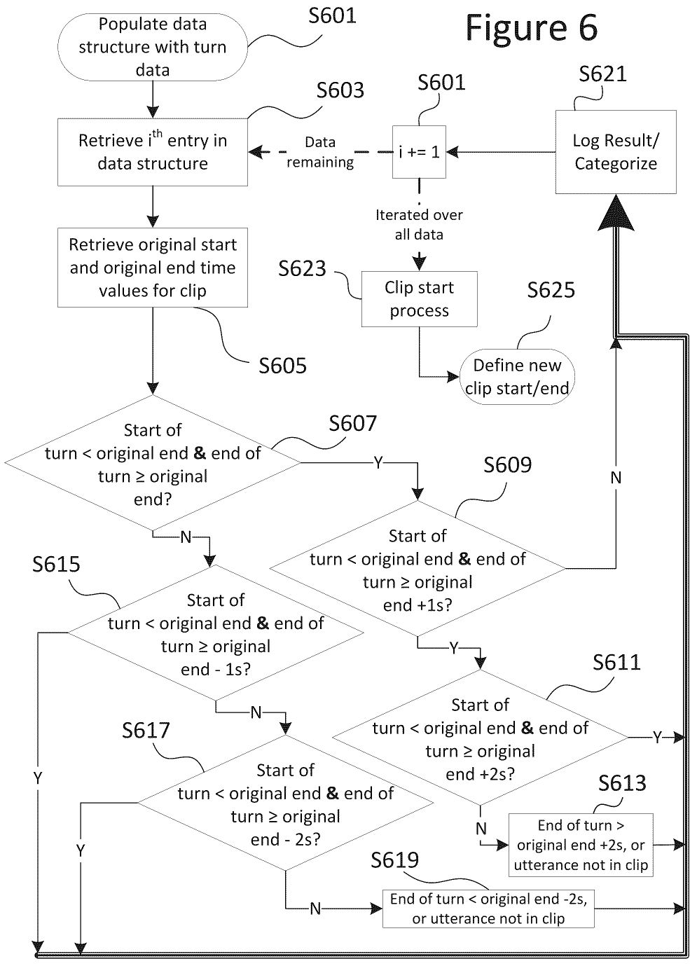

A post processing step S7 may be carried out to improve the continuity of the video clip as described later with reference to FIG. 6.

Operation of the paragraph generator 108 will now be described. Text which is extracted from the subtitles (whether directly as text, or by speech-to-text conversion) is supplied to the paragraph generator. The subtitles are divided into sentences or “virtual sentences”, each associated with an index. Each sentence (or virtual sentence) comprises a sequence of words extracted directly from a subtitle text, and in the order in which they appear in the subtitle text.

Whether or not a sentence of the subtitle is divided into a virtual sentence or not, depends on the required duration. This duration corresponds to the time duration of the sentence or virtual sentence as measured by its start and end time codes. A desirable duration is provided to the paragraph generator in order to determine how to divide the subtitles into sentences or virtual sentences. Each sentence/virtual sentence has a duration measured from its start code to the end of the word closest to a desired average length. Due to differing word lengths, each sentence/virtual sentence may differ from the desired average length by a small amount.

In one example, the duration is determined by the required duration of the video clip which will ultimately be generated. If, as a non-limiting example, the intended length of the video clip is 30 seconds, it may be appropriate to provide in each paragraph 15 sentences or virtual sentences, of an average length of two seconds.

FIG. 5A illustrates the original subtitles divided into sentences/virtual sentences based on the time of duration. In FIG. 5A, reference numeral 500 denotes the indices associated with each sentence/virtual sentence.

The first word sequence (constituting a virtual sentence) is referenced by index 1 and begins at time code 00:00:22, 400. This time code is denoted by reference numeral 502. Generally, in FIG. 5A reference numeral 502 denotes the start time codes of each word sequence.

The word sequence reads:
“my guest tonight is a maverick in”. The last word ends at the end time code 00:00: 24, 800, giving the word sequence a duration of 2.4 seconds. The end time code is referenced by reference numeral 504. The reference numeral 504 in FIG. 5A generally denotes the end time codes of each word sequence.

The second word sequence is denoted by index no. 2 and begins at start time code 00:00:24, 800. The word sequence reads “every sense of the word”. The end time code 504 is 00:00:26, 900, giving a duration of 2.1 seconds.

Note that the original full sentence “my guest tonight is a maverick in every sense of the word” has been split into two virtual sentences in order to achieve a duration of around 2 seconds for the purpose of indexing each individual word sequence. This to enable the overall duration of each paragraph (and therefore the duration of the associated video clip) to be controlled.

The next word sequence is index no. 3 and begins at time code 00:00:27, 100. Note that there is a space between the end time code of the word sequence indexed no. 2 and the start time code of the word sequence indexed no. 3. This could be a natural pause or some other sound effect or interruption.

Ten indexed word sequences are shown in FIG. 5A. it will be appreciated that the subtitles of the entire video are indexed in this way. Depending on the length of the origin video, this could be several 1000s of indexed sentences/virtual sentences. A paragraph is created by concatenating the thus created sentences or virtual sentences. That is, 15 (in the specific example given above) such sentences or virtual sentences may be concatenated (in the sequence in which they appeared in the subtitles as the video is played) to form a paragraph. The full stops which would normally occur at the end of each proper sentence are removed. For example, the full stop at the end of the word sequence indexed 2 in FIG. 5a is removed. Instead, a single full stop is provided at the end of the 15 concatenated sentences/virtual sentences to indicate that a paragraph has now been formed.

As mentioned, each sentence or virtual sentence is associated with a particular index. The indices with their corresponding sentences/virtual sentences and associated start and end time codes are stored in the subfile 116.

A full stop at the end of the concatenated sentences indicates that a paragraph has been defined. When the text selection component is implemented by the BERT model as described herein, that model automatically generates a paragraph index each time it reaches a full stop in the incoming text. Thus, a paragraph index is generated by the model which associates each incoming paragraph with an appropriate paragraph index. Operation of the BERT model to identify text of significance in the paragraphs which are supplied to it, is known from the above referenced paper “Papers with code—Leveraging BERT for Extractive Text Summarisation on Lectures 2019” (the BERT paper), the contents of which are herein incorporated by reference.

A brief summary is given herein for the sake of completeness.

Automatic extracted text summarisation is a technique which has been utilised for collecting key phrases and sentences, for example for the purpose of summarising lectures. A deep learning model known as BERT (Bi-directional Encoder Representations from Transformers) has been developed by Google which has a high performance of text summarisation. Google has released two BERT models, one with a 110 million parameters and the other with 340 million parameters as described for example in a paper by Devlin, J et al of 2018 entitled BERT: Pretraining of Deep Bi-directional Transformers of Language Understanding.

In order to use the BERT model, the subtitles are formed into incoming paragraphs, which resemble sentences to the BERT model. The paragraphs are each tokenised, and the tokenised paragraphs are passed to the BERT model for inference to output embeddings. These are then clustered using K-means to output text of significance.

Using the default pre-trained BERT model, one can select multiple layers for embeddings. Using the [cls] layer of BERT produces the necessary N×E matrix for clustering, where N is the number of sentences (paragraphs in this instance) and E is the dimension of the embedding,

Once the N−2 layer embeddings are completed, the N×E matrix is ready for clustering. A clustering parameter K is supplied which represents the number of clusters (paragraphs) for the final summary output.

Prior applications of the BERT model have concentrated on providing text summarisation, for example of lectures (including video lectures using subtitles). The text summarisation is in the form of a text output, such as pdf. The present inventors have used the output in a novel way, to generate one or more video clip.

In the original use case for the model number of sentences was used to extract only a certain number of sentences as a text summarization. For the purpose of the present application to generate a video clip of a certain duration, the input data is re-engineered as has been described above:
firstly, subtitles are converted into paragraphs with a full stop at the end so the BERT model can read it as a long sentence, each paragraph representing a video clip to be generated.
Secondly, the paragraphs are used as input for the BERT model.
The model receives the clustering parameter K as input, where K is the number of paragraphs to be extracted as summarization. Each paragraph extracted will result in a separate video clip to be generated. That is, K represents the number of video clips.

FIG. 5B illustrates one example of the output from the BERT model. The BERT model outputs paragraphs which have been deemed to be significant based on the clustering. In FIG. 5B, the first paragraph P1 output from the BERT model comprises the word sequences which were indexed one through 15. Note that the BERT model has reindexed these by subtracting one from each index, because its indices start from 0. Therefore, the word sequences are now indexed 0 to 14.

The next paragraph considered of interest began at sentence indexed 572 (571 in FIG. 5B) and is shown as P2 in FIG. 5B.

The indices 500 in the output paragraphs are used to associate with the start and end time codes for the paragraphs deemed of interest. That is, the start time code for index 0 (1 in FIG. 5A) represents the time code associated with the start of the relevant paragraph, and the end time code of word sequence indexed 15 represents the end time code for the portion associated with that paragraph.

In the next paragraph P2, the start time code is identified from index 571 and the end time code is identified from the end code of index numbered 585 (that business with the team).

FIG. 6 shows a flowchart that represents an exemplary workflow for determining whether a video clip of a predefined length may be shortened or lengthened. A video clip may be selected for shortening at the end if a speaker within the video clip stops talking, i.e., finishes their sentence, before the end of the clip. A video clip may be selected for extending at the end if a speaker within the video clip is still talking when the video clip ends.

The flowchart of FIG. 6 begins at a step S601, in which a data structure is populated with turn data. Turn data may be extracted from a raw, or source video from which a video clip is to be extracted, and may provide information about a length and position of an utterance in the source video, and by whom the utterance was spoken. That is, each instance of turn data may indicate a temporal data point representing a time within the source video at which the speaker begins talking: a start of turn. Each instance of turn data may further indicate a temporal data point representing a time within the source video at which the speaker stops talking: an end of turn. Each instance of turn data may further indicate an identity of a speaker associated with the utterance.

In some examples, an instance of turn data may be represented as an array of the form: (turn. start, turn. end, speaker ID), wherein the turn. start and turn. end fields may comprise temporal values indicating a time instant within the source video, and the speaker ID field may comprise a name, code or other index value indicating a particular speaker. One instance or element of turn data may represent one utterance by a particular speaker in the source video. It will be appreciated that other fields may exist in an element of turn data, such as values indicating an importance of the utterance in the context of the source video.

At a next step S603, an i^{th} entry in the turn data structure may be accessed. That is, a particular element of the turn data structure representing a first utterance by a first speaker may be accessed for processing.

Next, at a step S605, a predefined original start time and a predefined original end time of a video clip within the source video may be retrieved. That is, a video clip comprising a subset of the source video content may be predefined, and values respectively indicating time instances within the source video at which the video clip originally starts and ends may be retrieved.

Steps S607-S623 follow. These steps represent an exemplary process by which data may be generated for assessing the suitability of the original start and end times of the video clip. In particular, steps S607-S623 assess, for each instance of turn data, whether the utterance begins before the original end of the clip, and whether the utterance stops before or after the original end of the clip, and by how long.

At step S607, a determination is made regarding whether the start of the turn, e.g., the time value located in the turn. start field of the i^{th} turn data element, is less than (chronologically precedes) the original end time of the video clip, and whether the time value located in the turn. end field of the i^{th} turn data element is greater than or equal to (chronologically succeeds) the original end time of the video clip. As a result of the ‘AND’ logic, it will be appreciated that the determination at step S607 will only return TRUE, or ‘Y’, if both of the above conditions return TRUE. If either condition returns FALSE, the overall determination of step S607 returns FALSE.

If either condition in step S607 returns false and step S607 overall returns false, this indicates either that the speaker began speaking after the end of the clip, or that the end of the utterance precedes the end of the clip. Note that it is not possible for both conditions to be FALSE because the end time of an utterance cannot precede its start time. If S607 returns FALSE, the flow continues to a step S615, which is described later herein.

If the start of the turn precedes the original end of the video clip and the end of the turn succeeds or is equal to the original end of the video clip, i.e., if step S607 returns TRUE, the flow progresses to a step S609.

At step S609, a determination is made regarding whether the time value located in the turn. start field of the i^{th} turn data element chronologically precedes the original end time of the video clip, and whether the time value located in the turn. end field is greater than or equal to (chronologically succeeds) the original end time of the video clip plus 1 second. It will be appreciated that step S609 is only taken if step S607 returns TRUE. Therefore, step S609 represents an additional filter to those data elements that satisfy the conditions of step S607. Satisfaction of the conditions of step S609 additionally (over step S607) require that the end of the utterance chronologically succeeds the original end of the clip by at least 1s.

If step S609 returns FALSE, it may be inferred that the present turn data instance represents an utterance which begins before the original end of the clip, and ends a maximum of 1s after the original end of the clip. This inferred result may be stored in a results data structure in a step S621. The results data structure may comprise a plurality of bins or folders into which the results of each entry may be categorised. For example, the results data structure may comprise a distinct bin for entries representing utterances which return false at step S609, which begin before the original end of the clip, and end a maximum of 1s after then original end of the clip.

If step S609 returns TRUE, the flow continues to a step S611. Again, it will be appreciated that step S611 is only taken if step S609 returns TRUE. Therefore, step S611 represents an additional filter to those data elements that satisfy the conditions of step S609. Satisfaction of the conditions of step S611 additionally (over step S609) require that the end of the utterance chronologically succeeds the original end of the clip by at least 2s.

If step S611 returns FALSE, it may be inferred that the present turn data instance represents an utterance which begins before the original end of the clip, and ends between 1s and 2s after the original end of the clip. This inferred result may be stored in the results data structure at step S621.

If step S611 returns TRUE, the flow continues to a step S613. If a data element satisfies the conditions of step S611, it may be inferred at step S613 that the that the end of the presently assessed utterance chronologically succeeds the original end of the clip by at least 2s. Such a result may be stored in the results data structure at step S621. It will be appreciated that the flow may comprise any number of additional steps like S609 and S611, increasing the number of added seconds by one incrementally, such that utterances that end more than 2s after the original end of the clip may be categorised more precisely.

Returning to step S607, if the i^{th} data element, representing a particular utterance, returns FALSE at step S607, indicating either that the start of the utterance succeeds the original end of the clip or that the end of the utterance precedes the original end of the clip, the flow progresses to a step S615.

At S615, a determination is made as to whether the time value located in the turn. start field of the i^{th} turn data element, chronologically precedes the original end time of the video clip, and whether the time value located in the turn. end field is greater than or equal to (chronologically succeeds) the original end time of the video clip minus 1 second. It will be appreciated that step S615 is only taken if step S607 returns FALSE. Therefore, step S615 represents an additional filter to those data elements that do not satisfy either condition of step S607. Satisfaction of the conditions of step S615 require that the end of the utterance chronologically precedes the original end of the clip by a maximum of 1s. Such a result may be stored in the results data structure at step S621.

If step S615 returns FALSE, it may be inferred that the presently assessed data element represents an utterance that either begins after the original end of the video clip, or ends more than a second before original end of the video clip. If step S615 returns FALSE, the flow continues to a step S617.

Again, it will be appreciated that step S617 is only taken if step S609 returns FALSE. Therefore, step S617 represents an additional filter to those data elements that do not satisfy the conditions of step S615. Satisfaction of the conditions of step S617 require that the end of the utterance chronologically precedes the original end of the clip by a maximum of 2s.

However, if step S617 returns TRUE, it may be inferred from its prior failure to satisfy step S615 that the present turn data instance represents an utterance which begins before the original end of the clip, and ends between 1s and 2s before the original end of the clip. This inferred result may be stored in the results data structure at step S621; for example, in a distinct bin or folder for results that satisfy step S617.

If step S617 returns FALSE, the flow continues to a step S619. If a data element does not satisfy the conditions of step S619, it may be inferred at step S619 that the end of the presently assessed utterance chronologically succeeds the original end of the clip by at least 2s, or that the start of the utterance chronologically succeeds the original end of the video clip. Such a result may be stored in the results data structure at step S621.

Whilst not shown in the example of FIG. 6, it will be appreciated that the flow may comprise any number of additional steps like S615 and S617, increasing the number of subtracted seconds by one, incrementally, such that utterances that end more than 2s before the original end of the clip may be categorised more precisely.

Upon successfully storing results for a particular turn data element at step S621, the flow may progress to a step S623, in which an index of the data element to be assessed by may incremented. That is, the index parameter i may be incremented. Step S623 may then continue back to step S603, wherein the i^{th} entry in the turn data structure is retrieved, noting that the i^{th} entry corresponds to the newly incremented indexing parameter i.

If, however, it is determined at step S601 that all data in the turn data structure has been iterated over, the flow may instead progress to a step S623, wherein a similar process is performed in respect of the start time of the video clip. That is, step S623 may comprise a process in which the turn start and end times are compared with the original start time of the clip to categorise a temporal distance between the original start time of the clip and the start and end times of the utterances. Results may be similarly stored before the flow continues to a final step S625, in which new start and/or end times of the clip may be defined based on data in the results data structure.

For example, step S625 may include a subtraction of an amount of time (e.g., x seconds) from the original start of the clip to define a new start time, such that the clip begins x seconds earlier (or later if x is negative) than it did originally. Step S625 may further include an addition of an amount of time (e.g., y seconds) to the original end of the clip to define a new end time, such that the clip ends y seconds later (or earlier if y is negative) than it did originally.

The system 100 may be implemented using any suitable hardware processors which execute computer readable instructions stored as a software program in suitable computer memory. The BERT model may be implemented as part of a system pipeline, or may be a stand alone computer on which the model is executed and to which the paragraphs from the paragraph generator are transmitted. The system may comprise one or more processors or other compute elements such as central processing units (CPUs) graphics processing units (GPUs) or field-programmable gate arrays (FPGAs). Computer storage is configured to store transiently or permanently any suitable data required for the operation of the system, including machine readable instructions which when executed cause the system to carry out the methods discussed herein. The storage may comprise any combination of random-access memory, read-only memory and storage devices such as solid state drives or hard disk drives.

The system may be configured to communicate with external systems. These may be services (such as the speech to text transcription service) hosted in a cloud computing environment, accessible by the system for example via suitable application programming interfaces (APIs) over the internet or another a suitable network connection.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (e.g., a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A computer system for selecting a video clip of one or more video segments from an origin video, the computer system comprising:
a data input configured to receive video data of origin video, the video data comprising video images and associated data;
a text extraction component configured to derive from the associated data text pieces and to store in a data structure timing information which indicates for each text piece the time in the video associated with that text piece;
a selection component configured to select from the derived text pieces one or more text piece of significance; and
a video clip generation component configured to extract from the data structure for each text piece of significance the time in the video associated with that piece of significance and to output as a video clip a portion of the video at that time.

2. The computer system of claim 1 wherein the associated data comprises text data embedded in the video data.

3. The computer system of claim 1 wherein the associated data comprises speech and wherein the computer system comprises a speed-to-text convertor configured to derive text pieces by converting the speech to text.

4. The computer system of claim 1 wherein the selection component comprises a Bidirectional Encoder Representations from Transformers (BERT) neural network.

5. The computer system of claim 3 wherein the selection component comprises a Queryable Extractible Summarizer.

6. The computer system of claim 1, wherein the video clip generation component is configured to output multiple video clips in sequence.

7. The computer system of claim 1 which comprises a paragraph generation component which is configured to receive a desired time of duration of a video clip, and to generate virtual sentences from the text data concatenated into paragraph, based on the desired time of duration.

8. The computer system of claim 1 which comprises a clip adjustment component which is configured to implement an adjustment of a time duration of the video clip based on speaker continuance.

9. The computer system of claim 8 wherein the clip adjustment component is configured to detect that a first speaker is continuing to speak after an original end of the video clip and to extend the duration of the video clip to an end time of the speaker continuance of the first speaker.

10. The computer system of claim 8 wherein the clip adjustment component is configured to detect that a second speaker has ceased speaking less than a predetermined time prior to the original end of the video clip, and to reduce the time of duration of the video clip by the predetermined time.

11. The computer system of claim 1 comprising a video rendering component configured to render images of the segment of the video in a screen container at a user device.

12. The computer system of claim 11 wherein the video rendering component is configured to render each video segment in a respective screen of a multiscreen user engagement experience.

13. A method for generating a video clip from an origin video, the method comprising:
receiving video data of an origin video, the video data comprising video images and associated data;
deriving from the associated data text pieces and storing in a data structure timing information which indicates for each text piece the timing of the video associated with that text piece;
selecting from the derived text pieces one or more text piece of significance; and
extracting from the data structure of each text piece of significance the timing of the video associated with that piece of significance and outputting as a video clip a portion of the video at that time.

14. The method of claim 13 wherein the associated data comprises text data embedded in the video data.

15. The method of claim 13 wherein the associated data comprises speech and wherein the method comprises converting the speech to text to derive the text pieces.

16. The method of claim 13 wherein selecting one more text piece of significance is carried out using a neural network.

17. The method of claim 13 comprising determining a common length for each of the derived text pieces and deriving the text pieces of a length which substantially matches the common length.

18. The method of claim 17 comprising determining the common length for the derived text pieces based on a desired time of duration of video clip, wherein the video clip comprises multiple sequential text pieces of the common length.

19. A computer program product, comprising a non-transitory computer-readable medium having computer-readable program code embodied therein to be executed by one or more processors, the program code including instructions to:
receive video data of an origin video, the video data comprising video images and associated data;
derive from the associated data text pieces and storing in a data structure timing information which indicates for each text piece the timing of the video associated with that text piece;
select from the derived text pieces one or more text piece of significance; and
extract from the data structure of each text piece of significance the timing of the video associated with that piece.
